(19) United States
(12) Patent Application Publication
(10) Pub. No.: US 2026/0057817 A1
(43) Pub. Date: Feb. 26, 2026

(54) Acceleration Sub-System for Real-Time Display Configuration

(71) Applicant: Apple Inc., Cupertino, CA (US)

(72) Inventors: Ido Y Soffair, Tel-Aviv (IL); Uri Nix, Haifa (IL); Assaf Menachem, Hod Hasharon (IL); Asher Yakov Ungar, Raanana (IL)

(21) Appl. No.: 18/815,488

(22) Filed: Aug. 26, 2024

(51) Int. Cl. G09G 3/20

(52) U.S. Cl. CPC G09G 3/2092

(57) ABSTRACT

Systems and methods include an electronic device with an acceleration sub-system to perform (e.g., accelerate) certain functions offloaded from software and/or hardware components within the electronic device. For example, the acceleration sub-system may receive an operating parameter and perform one or more functions using the operating condition to determine a display parameter for the image processing circuitry. For example, a first hardware accelerator may perform math functions, a second hardware accelerator may perform interpolations, a third hardware accelerator may perform precision and/or format conversions, and so on. By offloading the functions to the hardware accelerators, the software and/or hardware components of the electronic device may perform other functions, such as determining additional display parameters for the image processing circuitry. As such, the image processing circuitry may be adjusted prior to a frame of image data being displayed, thereby reducing or eliminating front-of-screen errors.

### BACKGROUND

The present disclosure relates generally to determining one or more display parameters for image processing circuitry within an electronic display.

An electronic device may include an electronic display to display frames of image data. The electronic device may also include image processing circuitry (e.g., display image processing circuitry) that processes image data to generate a frame of image data for display. The display parameters of the image processing circuitry may be adjusted based on different operating conditions (e.g., brightness, temperature, refresh rate) prior to the image processing circuitry generating the frame of image data. However, the operating conditions may change from frame to frame based on changes of the electronic device and/or ambient conditions. As such, the operating conditions may be received on a per-frame basis and the display parameters of the image processing circuitry may be adjusted prior to each frame, which may be time-consuming and resource intensive.

### SUMMARY

The present disclosure relates generally to electronic displays, and, more particularly, to improving the determination of a display parameter used to adjust one or more display parameters of image processing circuitry prior to displaying a frame of image data on the electronic display. As mentioned above, one or more display parameters of the image processing circuitry may be adjusted based on operating conditions. Since the operating conditions may change on a frame to frame basis, the operating conditions may be received prior to each frame and the display parameters of the image processing circuitry may be determined for each frame, which may be time intensive and resource intensive. Moreover, the image processing circuitry may include multiple different display parameters that may be adjusted based on the operating conditions, which may increase a number of display parameter determinations and increase computational burden for the electronic device. In certain instances, the image processing circuitry may not be adjusted until a time point that may be immediately before a time point in which a frame of image data may be presented on a display of the electronic device. For example, the determination for adjusting the image processing circuitry may include many different operating conditions. If the image processing circuitry is not adjusted, then the frame of image data may be delayed which may result in front-of-screen artifacts (e.g., perceivable image artifacts).

With the foregoing in mind, in some embodiments, the electronic device may include an acceleration sub-system to perform (e.g., accelerate) certain functions offloaded from software and/or hardware components within the electronic device. For example, the acceleration sub-system may receive an operating parameter and perform one or more functions using the operating condition to determine a display parameter for the image processing circuitry. In certain instances, the acceleration sub-system may include one or more hardware accelerators that perform a respective function using a respective operating condition to generate a display parameter. For example, a first hardware accelerator may perform math functions, a second hardware accelerator may perform interpolations, a third hardware accelerator may perform precision and/or format conversions, and so on. The hardware accelerators may individually or collectively determine the display parameter. By offloading the functions to more efficient hardware accelerators, the software and/or hardware components of the electronic device may perform other functions, such as determining additional display parameters for the image processing circuitry, and/or remain idle to reduce power consumption. As such, the image processing circuitry may be adjusted prior to a frame of image data being displayed, thereby reducing or eliminating front-of-screen errors. Additionally or alternatively, latency between computations and computational burden on the software and/or hardware components may decrease.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a block diagram of the electronic device of FIG. 1, in accordance with an embodiment;

FIG. 8 is a flowchart of an example process for adjusting image processing circuitry of the electronic device of FIG. 1 based on operating conditions, in accordance with an embodiment;

FIG. 9 is a block diagram of the electronic device of FIG. 1, in accordance with an embodiment;

FIG. 10 is a block diagram of the electronic device of FIG. 1, in accordance with an embodiment;

FIG. 11 is a block diagram of the electronic device of FIG. 1, in accordance with an embodiment;

FIG. 12 is a flowchart of an example process for adjusting the image processing circuitry of the electronic device of FIG. 1, in accordance with an embodiment;

FIG. 13 is a flowchart of an example process for generating a display parameter (e.g., combined look-up table) for the image processing circuitry of the electronic device of FIG. 1, in accordance with an embodiment;

FIG. 14 is a flowchart of an example process for generating a display parameter for the image processing circuitry of the electronic device of FIG. 1, in accordance with an embodiment; and

FIG. 15 is a flowchart of an example process for generating a display parameter for the image processing circuitry of the electronic device of FIG. 1, in accordance with an embodiment, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment,” “an embodiment,” “embodiments,” and “some embodiments” of the present disclosure are not intended to be interpreted as excluding the existence of additional embodiments that also incorporate the recited features.

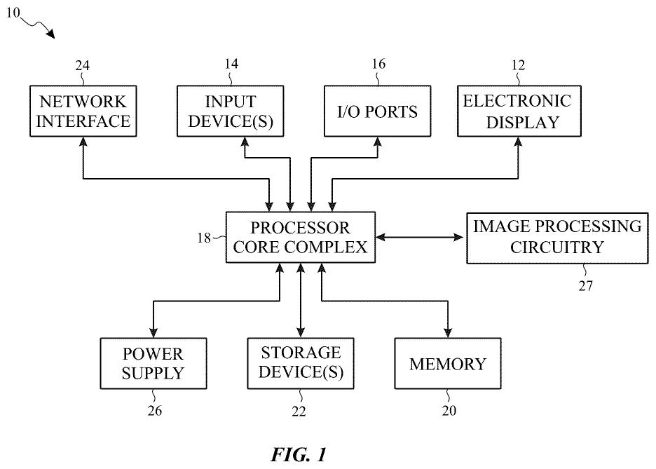

As discussed above, an electronic device may include an acceleration sub-system that performs tasks (e.g., functions) to determine display parameters for image processing circuitry. For example, the acceleration sub-system may receive an operating condition from the hardware and/or software components (e.g., processor core complex, local memory, system memory) within the electronic device, generate a display parameter by performing a function on the operating condition, and transmit (e.g., write) the display parameter to the image processing circuitry. As such, current display parameters of the image processing circuitry may be adjusted based on the display parameter transmitted from the acceleration sub-system. Then, the adjusted image processing circuitry may adjust image data to generate a frame of image data for display on the electronic display. Additional details with regard to employing the hardware accelerators and the image processing circuitry to generate and/or display a frame of image data will be discussed below with reference to FIGS. 1-16.

To help illustrate, an example of an electronic device 10, which includes and/or utilizes an electronic display 12 (e.g., display panel), is shown in FIG. 1. As will be described in more detail below, the electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

In addition to the electronic display 12, as depicted, the electronic device 10 includes one or more input devices 14, one or more input/output (I/O) ports 16, a processor core complex 18 having one or more processors or processor cores, main memory 20, one or more storage devices 22, a network interface 24, a power supply 26, and image processing circuitry 27. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the main memory 20 and a storage device 22 may be included in a single component. Additionally or alternatively, the image processing circuitry 27 may be included in the processor core complex 18 or the electronic display 12.

As depicted, the processor core complex 18 is operably coupled with main memory 20 and the storage device 22. As such, in some embodiments, the processor core complex 18 may execute instructions stored in main memory 20 and/or a storage device 22 to perform operations, such as generating image data. Additionally or alternatively, the processor core complex 18 may operate based on circuit connections formed therein. As such, in some embodiments, the processor core complex 18 may include one or more general purpose microprocessors, one or more application specific processors (ASICs), one or more field programmable logic arrays (FPGAs), or any combination thereof.

In addition to instructions, in some embodiments, the main memory 20 and/or the storage device 22 may store data, such as image data. Thus, in some embodiments, the main memory 20 and/or the storage device 22 may include one or more tangible, non-transitory, computer-readable media that store instructions executable by processing circuitry, such as the processor core complex 18 and/or the image processing circuitry 27, and/or data to be processed by the acceleration sub-system 62. For example, the main memory 20 may include random access memory (RAM) and the storage device 22 may include read only memory (ROM), rewritable non-volatile memory, such as flash memory, hard drives, optical discs, and/or the like.

As depicted, the processor core complex 18 is also operably coupled with the network interface 24. In some embodiments, the network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a 4G or LTE cellular network. In other words, in some embodiments, the network interface 24 may enable the electronic device 10 to transmit data (e.g., image data) to a communication network and/or receive data from the communication network.

Additionally, as depicted, the processor core complex 18 is operably coupled to the power supply 26. In some embodiments, the power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter.

Furthermore, as depicted, the processor core complex 18 is operably coupled with one or more I/O ports 16. In some embodiments, the I/O ports 16 may enable the electronic device 10 to interface with another electronic device 10. For example, a portable storage device may be connected to an I/O port 16, thereby enabling the electronic device 10 to communicate data, such as image data, with the portable storage device.

As depicted, the processor core complex 18 is also operably coupled with one or more input devices 14. In some embodiments, an input device 14 may enable a user to interact with the electronic device 10. For example, the input devices 14 may include one or more buttons, one or more keyboards, one or more mice, one or more trackpads, and/or the like. Additionally, in some embodiments, the input devices 14 may include touch sensing components implemented in the electronic display 12. In such embodiments, the touch sensing components may receive user inputs by detecting occurrence and/or position of an object contacting the display surface of the electronic display 12.

In addition to enabling user inputs, the electronic display 12 may facilitate providing visual representations of information by displaying one or more images (e.g., image frames or pictures). For example, the electronic display 12 may display a graphical user interface (GUI) of an operating system, an application interface, text, a still image, or video content. To facilitate displaying images, as will be described in more detail below, the electronic display 12 may include a display panel with one or more display pixels.

As described above, an electronic display 12 may display an image by controlling luminance of its display pixels based at least in part on image data associated with corresponding image pixels (e.g., points) in the image. In some embodiments, image data may be generated by an image source, such as the processor core complex 18, a graphics processing unit (GPU), and/or an image sensor. Additionally, in some embodiments, image data may be received from another electronic device 10, for example, via the network interface 24 and/or an I/O port 16. In any case, as described above, the electronic device 10 may be any suitable electronic device.

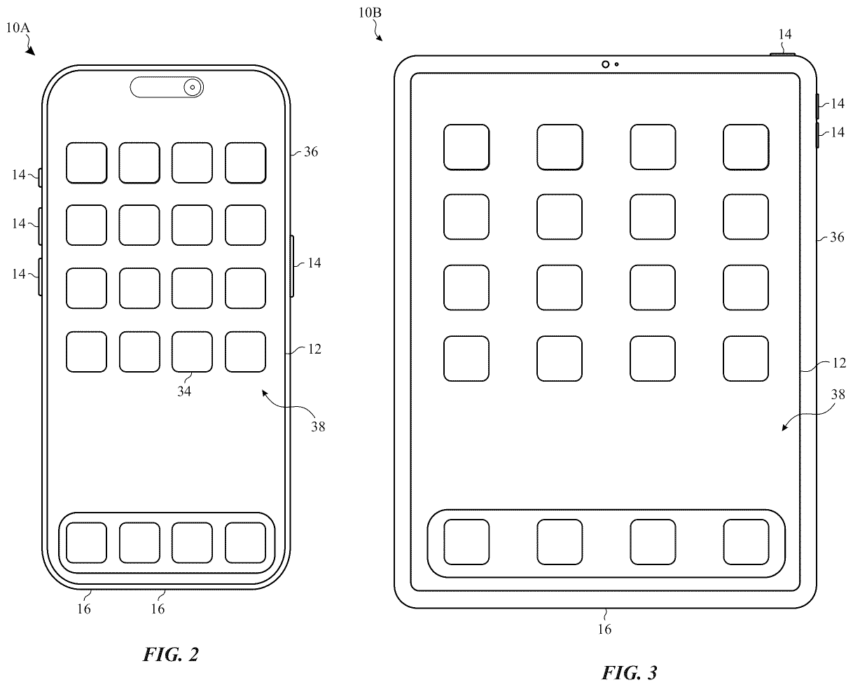

To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For example, the handheld device 10A may be a smart phone, such as any iPhone® model available from Apple Inc.

As depicted, the handheld device 10A includes an enclosure 36 (e.g., housing). In some embodiments, the enclosure 36 may protect interior components from physical damage and/or shield them from electromagnetic interference. Additionally, as depicted, the enclosure 36 surrounds the electronic display 12. In the depicted embodiment, the electronic display 12 is displaying a graphical user interface (GUI) 38 having an array of icons 34. By way of example, when an icon 34 is selected either by an input device 14 or a touch sensing component of the electronic display 12, an application program may launch.

Furthermore, as depicted, input devices 14 open through the enclosure 36. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. As depicted, the I/O ports 16 also open through the enclosure 36. In some embodiments, the I/O ports 16 may include, for example, an audio jack to connect to external devices.

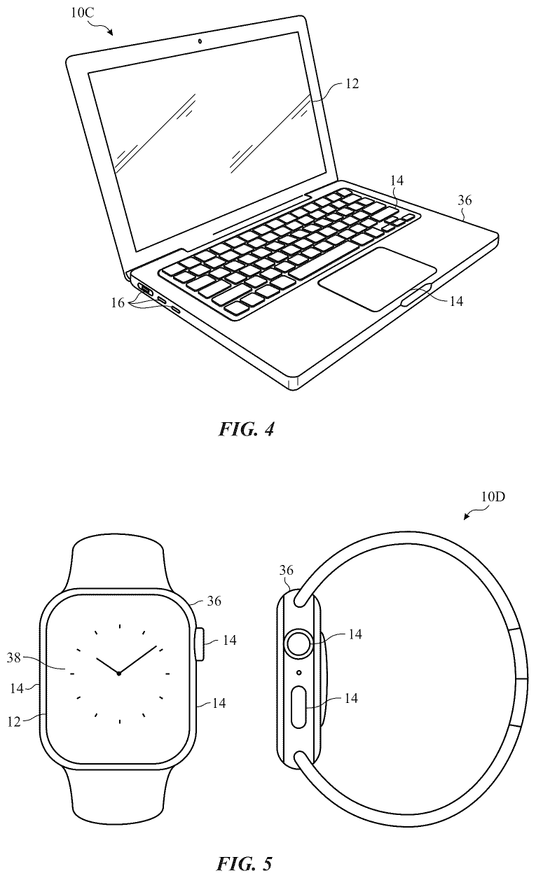

To help further illustrate, another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be any Apple Watch® model available from Apple Inc. As depicted, the tablet device 10B, the computer 10C, and the watch 10D each also includes an electronic display 12, input devices 14, I/O ports 16, and an enclosure 36. In any case, as described above, an electronic display 12 may generally display images based at least in part on image data, for example, output from the processor core complex 18 and/or the image processing circuitry 27.

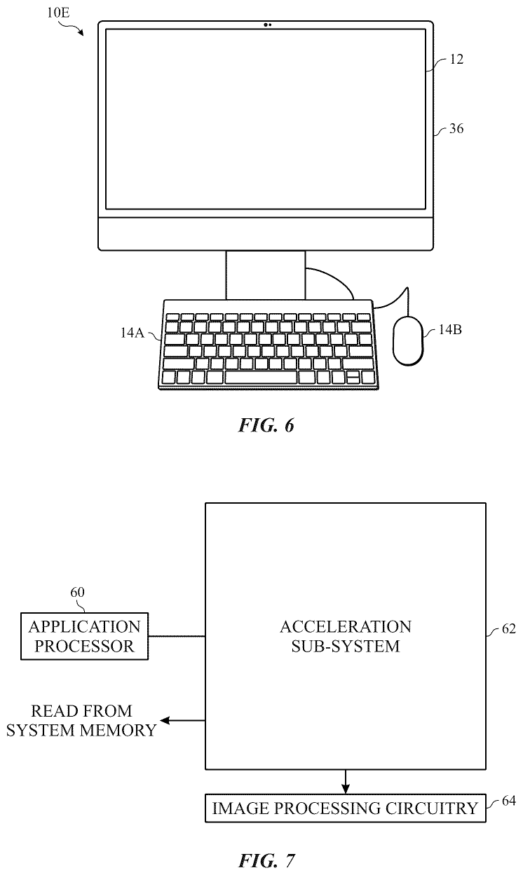

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input structures 14, such as the keyboard 14A or mouse 14B (e.g., input structures 14), which may connect to the computer 10E.

To help illustrate, a portion of the electronic device 10, including an application processor (e.g., processing circuitry) 60, an acceleration sub-system 62, and image processing circuitry 64, is shown in FIG. 7. The application processor 60, the acceleration sub-system 62, and/or the image processing circuitry 64 may be implemented within the electronic device 10. For example, the application processor 60, the acceleration sub-system 62, and/or the image processing circuitry 64 may be included in the processor core complex 18 illustrated in FIG. 1. The application processor 60, the acceleration sub-system 62, and/or the image processing circuitry 64 may include any suitable hardware and/or software components to carry out the techniques discussed herein.

The application processor 60 may receive, calculate, and/or retrieve an operating condition. For example, the application processor 60 may be communicatively coupled to a sensor that generates sensor data indicative of operating conditions (e.g., brightness, temperature, refresh rate) including ambient light conditions, a temperature, and so on. In another example, the application processor 60 may receive, generate, and/or calculate dynamic operating conditions, such as but not limited to a refresh rate, a frame duration, and the like, from display driver software that may be implemented within the processor core complex 18 and/or the application processor 60. The application processor 60 may also retrieve operating conditions including calibration data from system memory (e.g., memory 20 described with respect to FIG. 1). The calibration data may include a set of display parameters of the image processing circuitry 64. Additionally or alternatively, the application processor 60 may generate a frame of image data and transmit the frame of image data to the acceleration sub-system 62 for processing.

As discussed herein, the operating condition may change from frame to frame due to various parameters of the electronic device 10 and/or the environment of the electronic device 10. The operating condition may include a temperature, a brightness value of the electronic display 12, location temperature variations, one or more refresh rates, a frame duration, ambient light conditions, a type of the electronic device 10, a type of the electronic display 12, calibration data, and so on. For example, temperature of the electronic device 10 may be dynamic and may change from frame to frame. In another example, the electronic device 10 may move from a bright location to a darker location, and as such, the brightness of the electronic display 12 may change. Still in another example, the operating condition may be determined by the display driver and transmitted to the application processor 60.

The application processor 60 may perform one or more operations on the operating condition to generate a display parameter and transmit (e.g., write) the display parameter to the image processing circuitry 64. For example, the application processor 60 may perform a mathematical function using the operating condition to generate the display parameter. The application processor 60 may write the display parameter to one or more blocks and/or one or more registers of the image processing circuitry 64.

The application processor 60 may transmit the operating condition to the acceleration sub-system 62 to generate a display parameter. The acceleration sub-system 62 may perform one or more “repetitive” tasks that may be offloaded from the application processor 60. For example, a “repetitive” task may include a frequently performed mathematical function. In another example, a “repetitive” task may include writing the display parameter to the image processing circuitry 64. Rather than burden the application processor 60 with the repetitive tasks, the acceleration sub-system 62 may perform and/or accelerate the task and write the display parameter to the image processing circuitry 64. As such, the acceleration sub-system 62 may free up bandwidth of the application processor 60 and/or a number of tasks performed by the application processor 60. Additionally or alternatively, the acceleration sub-system 62 may perform the tasks more efficiently in comparison to software, thus leading to a reduction in power consumption.

The acceleration sub-system 62 may include a hardware and/or software component that performs a respective operation. For example, the acceleration sub-system 62 may include a processor coupled to one or more accelerators. For example, the processor may perform one or more operations using the operating condition to generate a display parameter. In other examples, the processor may perform one or more operations using the operating condition to generate the display parameter and pass the display parameter to the one or more accelerators for additional operations. The accelerator may write the display parameter to the image processing circuitry 64.

The processor may include hardware components that includes logic for performing custom operations. Additionally or alternatively, the processor may receive custom processor instructions (e.g., custom instructions extension) and may be programmed via the custom processor instructions to perform customized functions (e.g., operations) using the operating conditions. For example, a user may create one or more custom operations for the processor to perform. The user may generate the custom processor instructions, which may include the custom operations, and implement the custom operations by loading and/or storing the custom processor instructions on the processor. The user may also update and/or adjust the custom operations, generate new custom processor instructions, and load and/or store the new custom processor instructions onto the processor. As such, the processor may perform custom operations using the operating conditions and/or receive updates and/or adjustments to the custom operations.

The one or more accelerators may be programmed and/or re-programmed to accelerate a function (e.g., operation). For example, each accelerator may perform a respective function, such as a mathematical function, an interpolation, a precision conversion, and so on. In certain instances, the processor may update and/or adjust the function of the respective accelerators. As further described with respect to FIGS. 9-11, the acceleration sub-system 62 may include one or more accelerators (e.g., hardware accelerator, acceleration processor, processor, accelerator) that receive the operating condition and perform the operation using the operating condition.

The acceleration sub-system 62 may receive the operating condition and generate one or more display parameters for the image processing circuitry 64. The acceleration sub-system 62 may determine a display parameter or a set of display parameters to write to the image processing circuitry 64 based on the operating parameter. The acceleration sub-system 62 may be constrained to a period of time to determine the display parameter and write the display parameter to the image processing circuitry 64 to reduce and/or eliminate delays in displaying a frame of image data. To generate the display parameter, the acceleration sub-system 62 may perform one or more operations using the operating condition to generate one or more display parameters. The acceleration sub-system 62 may perform the operations based on instructions and/or data stored in local memory, which may decrease latency of the operation. Additionally or alternatively, the acceleration sub-system 62 may accelerate the operation using the instructions (e.g., custom processor instructions), the processor, and/or the accelerators. As such, latency in determining the updated display parameters and transmitting the updated display parameters to the image processing circuitry 64 may decrease.

The acceleration sub-system 62 may transmit (e.g., write) the display parameter to the image processing circuitry 64. The acceleration sub-system 62 may write the display parameter to one or more blocks and/or one or more registers of the image processing circuitry 64. The image processing circuitry 64 may subsequently generate a frame of image data based on the display parameter and the image data. The image processing circuitry 64 may program the frame of image data into the electronic display 12 and drive the electronic display 12 to display the frame.

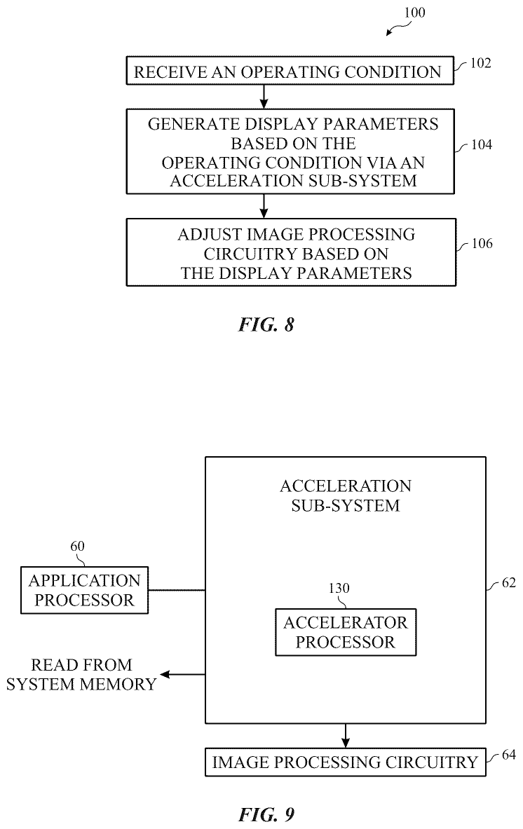

FIG. 8 is a flowchart of an example process 100 adjusting the image processing circuitry 64 of the electronic device 10 based on operating conditions. For example, the application processor 60 may receive and/or determine operating conditions of the electronic device 10 and/or the environment (block 102). The acceleration sub-system 62 may receive the operating conditions from the application processor 60 and determine display parameters by performing one or more operations on the operating conditions (block 104). The acceleration sub-system 62 may transmit the display parameters to the image processing circuitry 64 prior to the generation of a frame of image data for display (block 106).

At block 102, acceleration sub-system 62 may receive an operating condition. The acceleration sub-system 62 may receive and/or determine operating conditions from other components within the electronic device 10. For example, components of the electronic device 10 may write one or more operating conditions to local memory within the acceleration sub-system 62. In another example, the application processor 60 may transmit the operating conditions to the acceleration sub-system 62. Still in another example, the acceleration sub-system 62 may receive a refresh rate and/or a display brightness value from a display driver within the electronic device 10 and/or receive ambient light conditions and/or a temperature from a sensor within the electronic device 10.

At block 104, the acceleration sub-system 62 may generate a display parameter based on the operating condition via an acceleration sub-system 62. The acceleration sub-system 62 may include instructions stored in a local memory to accelerate one or more functions. The acceleration sub-system 62 may perform one or more functions using the operating condition to generate the display parameter.

At block 106, the acceleration sub-system 62 may adjust image processing circuitry 64 based on the display parameter. For example, the acceleration sub-system 62 may transmit the display parameter to the image processing circuitry 64 to adjust the image processing circuitry 64. Additionally or alternatively, the application processor 60 may generate one or more display parameters based on the operating condition and transmit the one or more display parameters to the image processing circuitry 64 for adjustment. For example, the application processor 60 and the acceleration sub-system 62 may concurrently generate display parameters based on one or more operating conditions used to adjust the image processing circuitry 64. The image processing circuitry 64 may subsequently process a frame of image data and drive the electronic display 12 to display the frame of image data. For example, the image processing circuitry 64 may include one or more blocks that adjust a color and a brightness of the image data, performs uniformity compensation, and so on. As such, image fidelity may be improved.

While the process of FIG. 8 is described using process blocks in a specific sequence, it should be understood that the present disclosure contemplates that the described process blocks may be performed in different sequences than the sequence illustrated, and certain described process blocks may be skipped or not performed altogether.

FIG. 9 is a block diagram of a portion the electronic device 10. The electronic device 10 of FIG. 9 is substantially similar to the electronic device of FIG. 6, except the electronic device 10 of FIG. 9 includes an accelerator processor 130 implemented within the acceleration sub-system 62. The accelerator processor 130 may be enclosed within the acceleration sub-system 62 such that the accelerator processor 130 may not depend on other components (e.g., system-on-chip, system memory, memory 20) of the processor core complex 18 for performance and condition time. In operation, the accelerator processor 130 may operate as a hardware block and/or a real-time processor. For example, the accelerator processor 130 may be programmed to perform certain tasks and re-programmed to perform different tasks.

The accelerator processor 130 may fetch operating conditions, calibration data, and/or operating instructions from a local memory within the accelerator sub-system 62. The accelerator processor 130 may receive the operating condition from the application processor 60 and/or the local memory and perform an operation on the operating condition to generate a display parameter. For example, the accelerator processor 130 may perform a function using the operating condition to generate the display parameter. In certain instances, the accelerator processor 130 may perform custom functions received via user input. The accelerator processor 130 may transmit the display parameter to the image processing circuitry 64 to adjust the image processing circuitry 64.

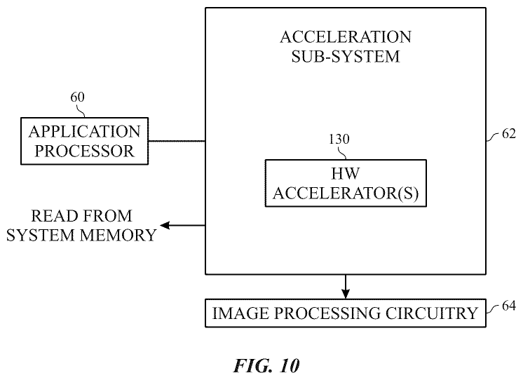

FIG. 10 is a block diagram of a portion of the electronic device 10. The electronic device 10 of FIG. 10 is substantially similar to the electronic device of FIG. 6, except the electronic device 10 of FIG. 10 includes hardware accelerators 150 implemented within the acceleration sub-system 62. The hardware accelerators 150 may receive the operating condition from the application processor 60, local memory, and/or system memory. As discussed herein, the hardware accelerators 150 may perform tasks offloaded from the application processor 60. For example, the hardware accelerators 150 may be programmed to perform repetitive tasks, such as a precision conversion, a mathematical function, and so on. To this end, the hardware accelerators 150 may be programmed to perform one task and may accelerate processing of the task. As such, the hardware accelerators 150 may reduce an amount of time used to determine the display parameter based on the operating condition and/or reduce computational burden on the application processor 60.

The hardware accelerators 150 may respectively include back-end logic to write the display parameter to the image processing circuitry 64. For example, the hardware accelerators 150 may write the display parameters to one or more blocks and/or one or more registers of the image processing circuitry 64. As such, the hardware accelerators 150 may perform one or more offloaded tasks from the application processor 60, thereby reducing computational burden on the application processor 60 and/or reducing latency between the computation and writing to the image processing circuitry 64.

In certain instances, the hardware accelerators 150 may be hardware blocks with limited programmability. For example, an address for data fetching, an address for data writing, a set of coefficients, and the like may be programmed and/or re-programmed into the hardware accelerators 150. In other instances, the hardware accelerators 150 may operate as a processor. For example, the hardware accelerators 150 may be programmable and/or re-programmable.

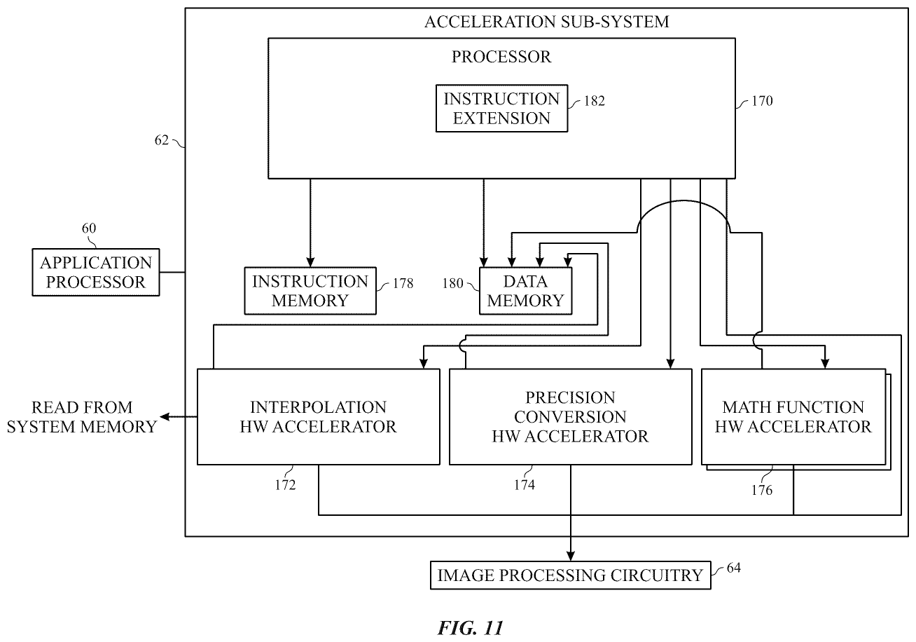

FIG. 11 is a block diagram of a portion of the electronic device 10. The electronic device of FIG. 11 is substantially similar to the electronic device of FIG. 6, except the electronic device of FIG. 11 includes a processor 170, a first hardware accelerator 172, a second hardware accelerator 174, and a third hardware accelerator 176 implemented within the acceleration sub-system 62.

The acceleration sub-system 62 may also include memories 178 and 180 for storing instructions, one or more operating conditions, one or more display parameters, calibration data, and the like. The memories 178, 180 may be local to the accelerator sub-system 62. For example, the memories 178, 180 may be dedicated registers to enable real-time operations performed by the accelerator sub-system 62 to be completed within a time period prior to a point in time in which the image processing circuitry 64 adjusts image data and/or drives the electronic display 12 to display a frame of image data. The memories 178, 180 may include an instruction memory 178 and a data memory 180. The data memory 180 may store operating conditions, coefficients, address points, previous display parameters, and/or any suitable parameters used for acceleration by the hardware accelerators 172, 174, 176. The components within the electronic device 10 may write one or more operating conditions to the data memory 180. For example, a component may write the display brightness value of the electronic display 12 to the data memory 180. The processor 170 may retrieve the operating conditions from the data memory 180 and perform operations using the operating condition.

The acceleration sub-system 62 may include a processor 170 that stores custom instruction extensions 182. The custom instructions extensions 182 may include mathematical functions that may be performed by the processor 170. The processor 170 may receive the operating condition from the application processor 60 and/or the data memory 180 and perform mathematical function on the operating condition. In another example, the processor 170 may perform non-repetitive functions or functions that may not be offloaded to the hardware accelerators 172, 174, 176. The processor 170 may transmit the operating condition to the hardware accelerators 172, 174, 176 after operating on the operating condition.

The hardware accelerators 172, 174, 176 may receive the operating condition from the processor 170. As discussed below, the hardware accelerators 172, 174, 176 may perform an operation on the operating condition to generate the display parameter. The hardware accelerators 172, 174, 176 may be allotted a period of time (e.g., time budget) to complete the operation. The period of time may be any suitable amount of time prior to processing of a new frame of image data.

The first hardware accelerator 172 may perform interpolations and a real-time read. For example, the first hardware accelerator 172 may include a real-time direct memory access (DMA) engine that fetches data from system memory within the period of time. The first hardware accelerator 172 and the DMA engine may retrieve (e.g., fetch) two or more look-up tables based on the operating condition. The first hardware accelerator 172 may use the two or more look-up tables to generate a combined look-up table that may be written to the image processing circuitry 64. For example, the operating condition may be a brightness value between two brightness points. The first hardware accelerator 172 may generate a combined brightness look-up table that includes parameters at a lower brightness value and parameters at a higher brightness value. To generate the combined look-up table, the first hardware accelerator 172 may perform linear interpolation, bilinear interpolation, cubic interpolation, and so on. For example, the first hardware accelerator 172 may perform bilinear interpolation on four look-up table to generate the combined look-up table. In another example, the first hardware accelerator 172 may generate a combined look-up table brightness, frame duration, and temperature values for interpolation. The first hardware accelerator 172 may retrieve any suitable number of look-up tables to generate the combined look-up table. Additionally or alternatively, the first hardware accelerator 172 may generate the combined look-up table to include any suitable number of axis, such as two or more, three or more, four or more, and so on. In another example, the first hardware accelerator 172 may interpolate between values using a two-dimensional (2D) lookup table or a three-dimensional (3D) lookup table.

The first hardware accelerator 172 may also include a precision converter and packing logic. For example, the first hardware accelerator 172 may adjust the precision and/or format of each value of the combined look-up table to a precision used by the image processing circuitry 64. In another example, the first hardware accelerator 172 may pack the combined look-up table into a format and/or size suitable for the image processing circuitry 64. The first hardware accelerator 172 may also include back-end logic that writes the combined look-up table and/or the packed combined look-up table to the image processing circuitry 64.

The second hardware accelerator 174 may perform precision conversions. The second hardware accelerator 174 may convert the display parameter from the processor 170 from a first precision and/or format to a second precision and/or format. The first precision and/or format may be a suitable precision and/or format used by the processor 170. The second precision and/or format may be determined based on a precision and/or format used by the image processing circuitry 64. For example, the second hardware accelerator 174 may receive the operating condition as an integer (INT) and convert the operating condition to a floating-point number (FP). The second hardware component 174 may generate the display parameter as the floating-point number. In another example, the second hardware accelerator 174 may receive a look-up table from the processor 170 as the operating condition and convert the values of the look-up table from a first precision and/or format to a second precision and/or format. The converted operating condition may be the display parameter written by the second hardware accelerator 174 to the image processing circuitry 64. For example, the second hardware accelerator 174 may include back-end logic that writes the display parameter to local registers of the image processing circuitry 64.

The third hardware accelerator 176 may perform mathematical functions. The mathematical function may be programmed into the third hardware accelerator 176 and may include a polynomial function, an exponential function, a logarithmic function, a piecewise function, a hyperbolic function, a floating-point computation, Bezier curve calculations, and so on. For example, the third hardware accelerator 176 may retrieve calibration data from the data memory 180 and perform a mathematical function using the calibration data. In another example, the third hardware accelerator 176 may determine the display parameter based on the operating condition and the mathematical function. In certain instances, the third hardware accelerator 176 may perform multiple mathematical functions to generate the display parameter. The third hardware accelerator 176 may include back-end logic that writes the output from the mathematical function to the image processing circuitry 64.

The hardware accelerators 172, 174, 176 may receive the operating condition from the processor 170, other hardware accelerators, the data memory 180, the application processor 60. The operating condition may include an output from the application processor 60, an output from the processor 170, an output from the other accelerators, the calibration data within the data memory 180, and so on. In an example, the processor 170 may perform one or more operations using the operating condition and pass the operating condition to respective hardware accelerators 172, 174, 176. In another example, the first hardware accelerator 172 may receive the operating condition from the second hardware accelerator 174 and/or the third hardware accelerator 176, the second hardware accelerator 174 may receive the operating condition from the first hardware accelerator 172 and/or the third hardware accelerator 176, and the third hardware accelerator 176 may receive the operating condition from the first hardware accelerator 172 and/or the second hardware accelerator 174. The hardware accelerators 172, 174, 176 may write the display parameter to the image processing circuitry 64.

The display parameters may be transmitted (e.g., written) to the image processing circuitry 64. As such, the accelerator sub-system 62 may also perform the write task. In other words, the application processor 60 may offload the write task to the accelerator sub-system 62, which may provide additional bandwidth for the application processor 60 to perform other operations. As such, the image processing circuitry 64 may be adjusted using the display parameters from the acceleration sub-system 62 prior to generating a new frame of image data. Accordingly, the image processing circuitry 64 may operate in sync with both the frame of image data being presented and/or generated by the processor core complex 18 and physical conditions of the electronic display 12.

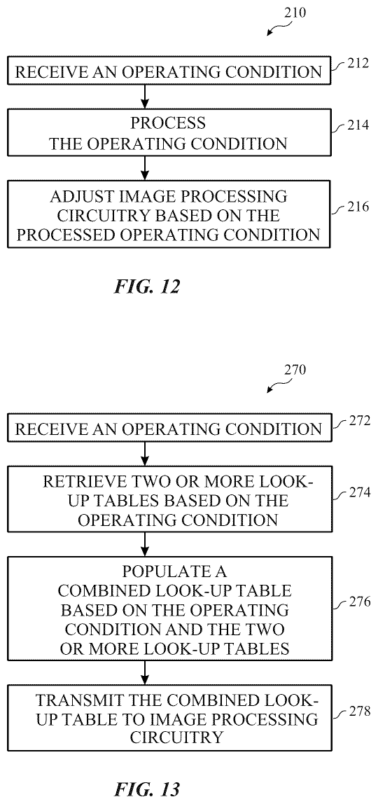

FIG. 12 is a flowchart of an example process 210 for adjusting the image processing circuitry 64 of the electronic device 10. The image processing circuitry 64 may include one or more display parameters that may be adjusted prior to the image processing circuitry 64 processes a frame of image data. As discussed herein, the accelerator sub-system 62 may receive an operating condition (block 212), process the operating condition (block 214), and adjust the image processing circuitry 64 based on the processed operating condition (block 216).

At block 212, the acceleration sub-system 62 may receive an operating condition, similar to block 102 described with respect to FIG. 8.

At block 214, the acceleration sub-system 62 may process the operating condition. For example, the accelerator sub-system 62 may process the operating condition to generate a display parameter. In another example, a processor 170 of the accelerator sub-system 62 may process the operating condition using one or more operations. Still in another example, a processor 170 of the accelerator sub-system 62 may process the operating condition and pass the processed operating condition to one or more accelerators 172, 174, 176 of the accelerator sub-system 62 for additional processing.

At block 216, the acceleration sub-system 62 may adjust the image processing circuitry 64 may be configured based on the processed operating condition. The accelerator sub-system 62 may write the display parameter to the image processing circuitry 64. For example, the accelerator sub-system 62 may write the display parameter to one or more blocks of the image processing circuitry 64, one or more registers of the image processing circuitry 64, and the like.

While the process of FIG. 12 is described using process blocks in a specific sequence, it should be understood that the present disclosure contemplates that the described process blocks may be performed in different sequences than the sequence illustrated, and certain described process blocks may be skipped or not performed altogether.

FIG. 13 is a flowchart of an example process 270 for generating the display parameter (e.g., combined look-up table) for the image processing circuitry 64 of the electronic device 10. For example, the first hardware accelerator 172 may receive an operating condition (block 272), retrieve two or more look-up tables based on the operating condition (block 274), populate a combined look-up table based on the two or more look-up tables and the operating condition (block 276), and transmit the combined look-up table to the image processing circuitry 64 (block 278).

At block 272, the acceleration sub-system 62 may receive an operating condition, similar to block 102 described with respect to FIG. 8.

At block 274, the acceleration sub-system 62 may retrieve two or more look-up tables based on the operating condition. The acceleration sub-system 62 may retrieve two or more look-up tables from the system memory (e.g., memory 20 described with respect to FIG. 1). The look-up tables may include values associated with an upper limit and a lower limit corresponding to the operating condition. For example, the acceleration sub-system 62 may retrieve a first look-up table corresponding to a first value greater than the operating condition and a second look-up table corresponding to a second value below the operating condition. The first look-up table and the second look-up table may include any suitable number of values. For example, the first hardware accelerator 172 may retrieve two more look-up tables from system memory (e.g., memory 20) based on the operating condition. The operating condition may include a temperature value and a brightness value. As such, the first hardware accelerator 172 may retrieve a first look-up table corresponding to temperature and a second look-up table corresponding to brightness. In another example, the system memory (e.g., memory 20) may store ten different brightness values, where each brightness value is stored in a look-up table with one-thousand values. The first hardware accelerator 172 may retrieve two look-up tables from the system memory based on the operating condition.

At block 276, the acceleration sub-system 62 may populate a combined look-up table based on the operating condition and the two or more look-up tables. The acceleration sub-system 62 may generate a combined look-up table by interpolating between the values of the first look-up table and the values of the second look-up table. For example, the first look-up table and the second look-up table may each include 500 values. The acceleration sub-system 62 may generate the combined look-up table by interpolating between the 500 values of the first look-up table and the 500 values of the second look-up table, respectively. In another example, the first hardware accelerator 172 may generate one look-up table with one-thousand values by interpolating between the two retrieved look-up tables. In another example, the first hardware accelerator 172 may interpolate between a first look-up table corresponding to temperature and a second look-up table corresponding to brightness to generate one look-up table corresponding to brightness and temperature.

At block 278, the acceleration sub-system 62 may transmit the combined look-up table to the image processing circuitry 64. For example, the acceleration sub-system 62 may write the combined look-up table to one or more blocks of the image processing circuitry 64. In another example, the accelerator sub-system 62 may write the look-up table to a block of the image processing circuitry 64. When processing a frame of image data, the image processing circuitry may interpolate between values of the combined look-up table to generate an output used to adjust the image data.

While the process of FIG. 13 is described using process blocks in a specific sequence, it should be understood that the present disclosure contemplates that the described process blocks may be performed in different sequences than the sequence illustrated, and certain described process blocks may be skipped or not performed altogether.

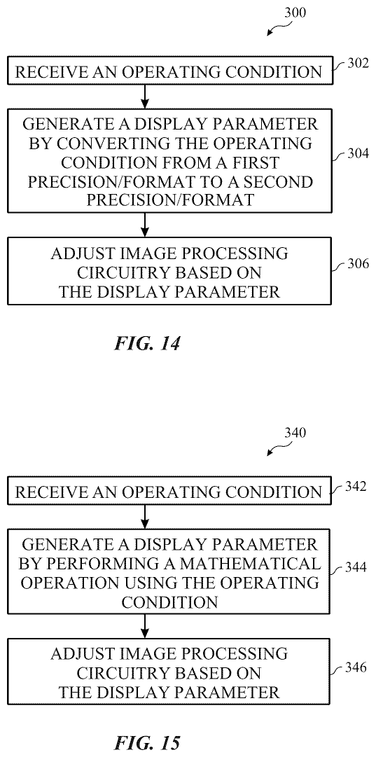

FIG. 14 is a flowchart of an example process 300 for generating the display parameter for the image processing circuitry 64 of the electronic device 10. For example, the second hardware accelerator 174 may receive an operating condition (block 272), generate a display parameter by converting the operating condition from a first precision and/or format to a second precision and/or format (block 304), and adjust the image processing circuitry 64 based on the display parameter.

At block 302, the acceleration sub-system 62 may receive an operating condition, similar to block 102 described with respect to FIG. 8. For example, the second hardware accelerator 174 may receive the operating condition from the processor 170. The operating condition may be in a first precision and/or format used by the processor 170.

At block 304, the acceleration sub-system 62 may generate a display parameter by converting the operating condition from a first precision and/or format to a second precision and/or format. The second hardware accelerator 174 may convert the operating condition from the first precision and/or format to a second precision and/or format used by the image processing circuitry 64. For example, the second hardware accelerator 174 may convert the operating condition from a floating-point number to an integer. In another example, the second hardware accelerator 174 may convert the operating condition from a first precision to a second precision. The second precision may be a higher precision or a lower precision than the first precision. The second precision may be a suitable precision for the image processing circuitry 64.

At block 306, the acceleration sub-system 62 may adjust the image processing circuitry 64 based on the display parameter similar to block 106 described with respect to FIG. 8 and block 216 described with respect to FIG. 12.

While the process of FIG. 14 is described using process blocks in a specific sequence, it should be understood that the present disclosure contemplates that the described process blocks may be performed in different sequences than the sequence illustrated, and certain described process blocks may be skipped or not performed altogether.

FIG. 15 is a flowchart of an example process 340 for generating the display parameter for the image processing circuitry 64 of the electronic device 10. For example, the third hardware accelerator 176 may receive an operating condition (block 342), generate a display parameter by performing a mathematical operation using the operating condition (block 344), and adjust the image processing circuitry 64 based on the display parameter (block 346).

At block 342, the acceleration sub-system 62 may receive an operating condition, similar to block 102 described with respect to FIG. 8.

At block 344, the acceleration sub-system 62 may generate a display parameter by performing a mathematical operation using the operating condition. The acceleration sub-system 62 may perform a polynomial function, an exponential function, a logarithmic function, a piecewise function, a hyperbolic function, a floating-point computation, Bezier curve calculations, and the like using the operating condition to generate the display parameter. For example, the third hardware accelerator 176 may perform the mathematical operation using the operating condition and output the display parameter.

At block 346, the acceleration sub-system 62 may adjust the image processing circuitry 64 based on the display parameter similar to block 106 described with respect to FIG. 8 and block 216 described with respect to FIG. 12.

While the process of FIG. 15 is described using process blocks in a specific sequence, it should be understood that the present disclosure contemplates that the described process blocks may be performed in different sequences than the sequence illustrated, and certain described process blocks may be skipped or not performed altogether.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S. C. 112(f). However, for any claims containing elements designated in any other manner, it is intended that such elements are not to be interpreted under 35 U.S. C. 112(f).

What is claimed is:

1. An electronic device, comprising:
image processing circuitry configured to generate a frame of image data; and
an acceleration sub-system configured to:
receive an operating condition;
generate a display parameter based on the operating condition; and
configure the image processing circuitry based on the display parameter.

2. The electronic device of claim 1, wherein the acceleration sub-system configures the image processing circuitry prior to the image processing circuitry generating the frame of image data.

3. The electronic device of claim 1, wherein the operating condition comprises a display brightness value, a temperature value, a frame duration, or an ambient condition.

4. The electronic device of claim 1, wherein the acceleration sub-system configures the image processing circuitry by writing the display parameter to at least one block of the image processing circuitry or at least one register of the image processing circuitry.

5. The electronic device of claim 1, wherein the acceleration sub-system comprises a processor configured to perform an operation using the operating condition to generate the display parameter.

6. The electronic device of claim 1, wherein the acceleration sub-system comprises a hardware accelerator configured to generate the display parameter by:
retrieving at least two look-up tables based on the operating condition; and
generating a combined look-up table by interpolating between each look-up table of the at least two look-up tables.

7. The electronic device of claim 1, wherein the acceleration sub-system comprises a hardware accelerator configured to generate the display parameter by:
converting the operating condition from a first format or a first precision to a second format or a second precision, wherein the second format is different from the first format, and wherein the second precision different from the first precision; and
generating the display parameter in the second format or the second precision.

8. The electronic device of claim 1, wherein the acceleration sub-system comprises a hardware accelerator configured to generate the display parameter by performing a mathematical function using the operating condition.

9. The electronic device of claim 1, wherein the acceleration sub-system comprises a local memory configured to store one or more operating conditions.

10. The electronic device of claim 1, wherein the acceleration sub-system comprises a plurality of hardware accelerators.

11. A method comprising:
receiving, via an accelerator sub-system, an operating condition;
generating, via the accelerator sub-system, a display parameter based on the operating condition; and
adjusting, via the accelerator sub-system, image processing circuitry based on the display parameter.

12. The method of claim 11, wherein generating, via the accelerator sub-system, the display parameter comprises:
retrieving two or more look-up tables from system memory based on the operating condition; and
generating the display parameter by interpolating between the two or more look-up tables.

13. The method of claim 11, wherein generating, via the accelerator sub-system, the display parameter comprises converting the operating condition from a first precision to a second precision.

14. The method of claim 11, wherein generating, via the accelerator sub-system, the display parameter comprises converting the operating condition from a first format to a second format.

15. The method of claim 11, wherein generating, via the accelerator sub-system, the display parameter comprises performing a mathematical function using the operating condition.

16. The method of claim 11, wherein adjusting, via the accelerator sub-system, the image processing circuitry comprises writing the display parameter to at least one block of the image processing circuitry or at least one register of the image processing circuitry.

17. A system comprising:
image processing circuitry comprising a plurality of display parameters and configured to generate a frame of image data; and
an accelerator sub-system configured to adjust a display parameter of the plurality of display parameters of the image processing circuitry prior to generation of the frame of image data, wherein the accelerator sub-system comprises:
a processor configured to:
retrieve an operating condition from local memory of the accelerator sub-system; and
perform an operation using the operating condition; and
a hardware accelerator configured to:
receive the operating condition from the processor;
generate an updated display parameter by performing an additional operation using the operating condition; and
adjust the display parameter by writing the updated display parameter to the image processing circuitry.

18. The system of claim 17, wherein generating the updated display parameter comprises converting the operating condition from a first precision and/or format to a second precision and/or format.

19. The system of claim 17, generating the updated display parameter comprises performing a mathematical function using the operating condition.

20. The system of claim 17, comprising:
a system memory configured to store a plurality of look-up tables,
wherein the accelerator sub-system comprises an additional hardware accelerator, wherein the additional hardware accelerator is configured to:
receive the operating condition from the processor;
retrieve two or more look-up tables of the plurality of look-up tables from the system memory;
generate a combined look-up table by interpolating between the two or more look-up tables; and
adjust the display parameter by writing the combined look-up table to the image processing circuitry.
